(19) United States
(12) Patent Application Publication
(10) Pub. No.: US 2008/0311544 A1
(43) Pub. Date: Dec. 18, 2008

(54) Free Angled Implant Driver and Free Angled Hole Implant Abutment

(76) Inventor: Jong Ho Lee, Youngin (KR)

Correspondence Address: IPLA P.A., 3580 WILSHIRE BLVD., 17TH FLOOR, LOS ANGELES, CA, 90010, US

(21) Appl. No.: 12/159,974

(22) PCT Filed: Jan. 2, 2007
(86) PCT No.: PCT/KR07/00002

§ 371 Date: Jul. 2, 2008

(30) Foreign Application Priority Data
Jan. 3, 2006 (KR) 10-2006-0000601
Jan. 2, 2007 (KR) PCT/KR2007/000002

(51) Int. Cl. A61C 3/02; A61C 8/00

(52) U.S. Cl. 433/173; 433/141

(57) ABSTRACT

In case of straight driver (100), The entrance of screw inserting hole of Implant prosthesis is on the same line with implant fixture's axis. Due to this position of the hole, final prosthesis has many difficulties. Thus. I invented the free angled driver (301). For maxillay anterior teeth, we can move the screw hole to lingual surface of prosthesis (511). we can make esthetic and convenient prosthesis with capability of easy screwing and unscrewing. Also. I invented the free angled hole abutment (300) for the free angled implant driver (301), so we can move occlusal hole to the ideal position. It is an epoch-making change to solve many problems in the contemporary dental implant prosthetics.

### TECHNICAL FIELD

Dental implant becomes a important part of contemporary dentistry. Dental implant is composed of three components, implant fixture (508) which is a implanted part in the bone; implant abutment (506) which is connected with implant fixture by screw; tooth shape prosthesis which is attached with implant abutment.

In most cases, when a implant abutment is fixed to implant fixture, a abutment screw (507) is screwed into a implant fixture by driver. In this case, the central axis of driver body, the central axis of implant abutment screw, and the central axis of implant fixture are all in one straight line. At this point of time, two types of driver was developed. One is the straight driver (100) and the other is the right angle driver system (101). The right angle driver system is useful when the patient can't open the mouth widely. This system has two components; driver shaft (106) and a driver edge (105). Driver shaft meets with it's driver handle at right angle. But, their shapes are the same straight type as the straight driver (100) at the portion of internal hole for screw of abutment (204).

### BACKGROUND ART

In case of straight driver, The entrance of screw inserting hole of Implant prosthesis is on the same line of implant fixture's axis. Therefore, the maxillary anterior implant has to be planted according to the shape of the alveolar bone, the anterior prosthesis is not esthetic because screw hole is on the labial side (500).

So, cement type prosthesis (601,602) has been using widely, for esthetic need. However, if screw loosening occurs, labial side should be perforated to access to the screw hole, prosthesis to remake.

Also. In other cases, anterior prosthesis (602) needs an angled abutment (613), because the angle between fixture with prosthesis is not the same. moreover, buccal margin of angled abutment became to thick, metal color will be appeared in the labial gingival margin. It is also a weak point.

In addition, for cement type, residual cement in the gingival pocket can be harmful for gingival health.

Another prosthesis (603) with lingual screw (616) has been introduced recently. It is too small to bear heavy torque. And thus, technique is difficult to make prosthesis and expensive. Lateral force can be produced in screwing tightly this lingual screw, therefore sometimes, screw and lingual screw breakage and implant failure will occur.

In the posterior tooth, screw type prosthesis is used widely. For screwing and unscrewing are very convenient, repair and plaque control are easily undertaked. But hole position of this prosthesis is occasionally unaesthetic, it is hard to use in anterior teeth, and the more in posterior teeth.

Recently, Screw-Cement-Retained-Prosthesis are introduced. It is easy to posterior teeth. But in anterior, also unaesthetic problem are existing.

And that, UCLA type prosthesis has a same problem to screw type.

### DISCLOSURE OF INVENTION

### Technical Problem

Driver should rotate in keeping the certain angle (311), and should support a torque demended, and should be easy to positioning the edge of driver. Especially, should change the rotation axis in internal tube of abutment (305).

### Technical Solution

Free angled driver has torque transmission part. And that is combination of a loop, a gear, a wire, or a tube

The free angled hole abutment (300) with the free angled implant driver (301), has the entrance of screw inserting hole (306) which is located apart from central axis line of abutment screw (606), at a distance

### ADVANTAGEOUS EFFECTS

If we use the free angled driver (301) and free angled hole abutment (300). In case of maxillay anterior teeth, we can move the screw hole to lingual surface of prosthesis (511). we can make esthetic and convenient prosthesis capable of screwing and unscrewing easily.

Also, posterior teeth, if use free angled hole abutment, we can move occlusal hole to the ideal position. There are many benefits in the function and the beauty.

Also, Screw-Cement-Retained-Prosthesis can make a epochal development due to this inventions.

### BRIEF DESCRIPTION OF THE DRAWINGS

FIG. 1—straight driver

FIG. 2—implant abutment

FIG. 3—a free angled hole abutment and a free angled driver

FIG. 4—an esthetic free angled hole abutment

FIG. 5—a comparison between a conventional abutment with a straight driver and a free angled hole abutment with a free angled driver in the prostheses

FIG. 6—a comparison between a free angled hole abutment with a free angled driver and two type conventional cement type/lingual screw type abutment with a straight driver in the prostheses

FIG. 7—the example of the free angled driver with one joint

FIG. 8—the example of the free angled driver with two joint

FIG. 9—the example of the free angled driver with two joint

FIG. 10—the example of the free angled driver with a path guiding tube

FIG. 11—the example of the free angled driver with a path guiding rod

FIG. 12—the example of the free angled driver having the handpice-type connection with a path guiding rod

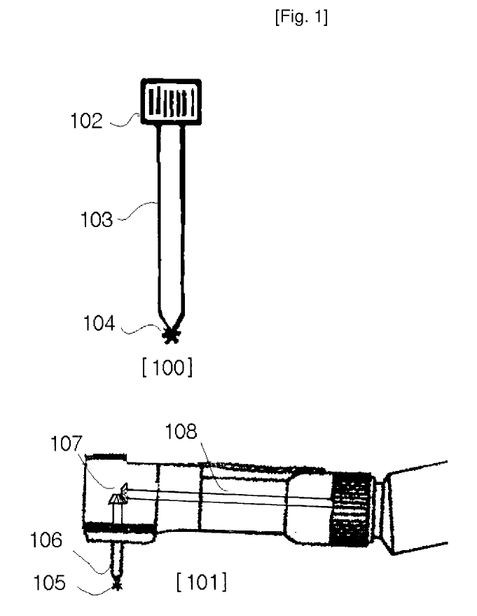

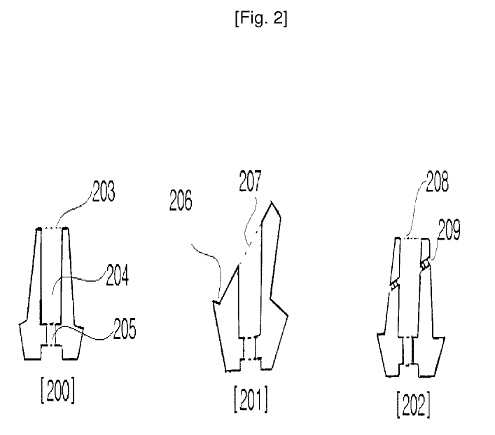

100—a straight driver
101—a handpice type screwing device having a right-angle
102—a driver handle
103—a driver shaft
104—a driver edge
105—a driver edge
106—a driver shaft
107—bevel gear
108—rotation axis of power
200—cemented-type straight abutment
201—cemented-type curved abutment
202—lingual-screw-type abutment
203—for screw inserting hole of abutment
204—internal tube for screw of abutment
205—entrance of screw inserting hole in fixture side of abutment
206—buccal prosthesis margin of angled abutment
207—entrance of screw inserting hole of angled abutment
208—entrance of screw inserting hole of lingual screw abutment
209—entrance of lingual screw inserting hole of lingual screw abutment
300—a free angled hole abutment
301—a free angled implant driver
302—buccal margin height of abutment
303—buccal margin of abutment
304—buccal surface of internal tube of abutment screw hole
305—internal tube in abutment screw hole
306—entrance of screw inserting hole
307—lingual margin of abutment
308—handle of driver
309—torque transmission part
310—a driver of working axis
311—an angle between driver handle and screw
312—a power axis of driver handle
313—screw axis fixed to implant, driver's axis
400—buccal prosthesis margin thickness of an esthetic free angled hole abutment
500—an example of a screw-type straight abutment prosthesis
501—an example of implant prosthesis using a free angled hole abutment and a free angled driver
502—driver handle
503—entrance of screw inserting hole of prosthesis
504—a driver shaft
505—entrance of screw inserting hole of abutment
506—screw-type straight abutment
507—abutment screw
508—implant fixture
509—internal inducing tube of screw inserting hole
510—a free angled driver with power transmission part in the internal tube
511—entrance of lingual screw inserting hole of prosthesis
512—entrance of lingual screw inserting hole of abutment
513—driver handle
514—an angle of driver handle between screw
600—an example of a free angled hole abutment
601—an example of a cement type straight abutment
602—an example of a cement type angled abutment
603—an example of a lingual screw type abutment
605—an inserting path of a free angled implant driver
606—central axis of implant abutment screw
607—an angle of screw axis and an inserting path of screw
608—a handle's axis of a free angled implant driver
609—an edge's axis of a free angled implant driver
610—an angle of a free angled implant driver's handle and edge
611—free angled hole abutment
612—a cement type straight abutment
613—a cement type angled abutment
614—a lingual screw type abutment
615—a cemental space
616—lingual screw
617—inserting hole orifice of lingual screw
700—0 degree rotation starting of a free angled driver
701—−45 degree rotation of a free angled driver
702—−90 degree rotation of a free angled driver
703—power transmission part of rotation ring joint
900—joint angle limiting device
1000—a path guiding device (tube)
1001—a free angled implant driver
1002—handpiece-type connection
1100—a anterior housing for a path guiding rod
1101—gear
1102—a path guiding rod
1103—a capping screw of a path guiding rod
1104—a capping of a path guiding rod
1105—a posterior housing for a path guiding rod
1200—a free angled implant driver
1201—a path guiding rod
1202—a housing for a path guiding rod
1203—a handpice-type connection

### BEST MODE FOR CARRYING OUT THE INVENTION

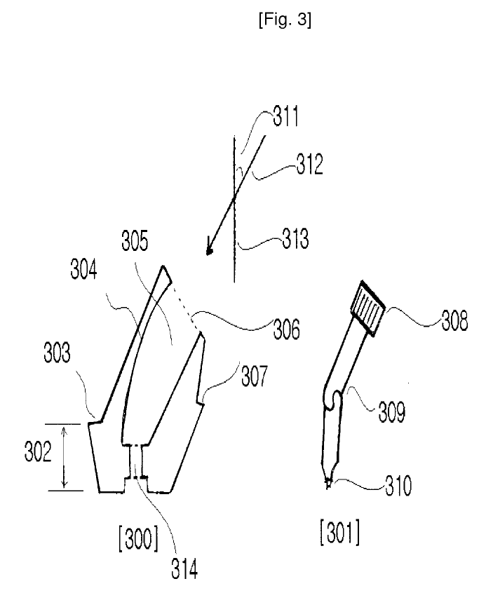

As illustrated in FIG. 3, The free angled implant driver has a torque transmission part (309) which can be consisted with 1 to 10 piece in number, and will be located within 10 mm from the working end of driver (310).

The free angled hole abutment (300) with the free angled implant driver (301), has the entrance of screw inserting hole (306) which is located apart from central axis line of abutment screw (606), at a distance

### MODE FOR THE INVENTION

The free angled implant driver (301) used for implant, are consist of a driver handle (308) or a handpiece-type connection (1002) of a power axis (312), a torque transmission part (309) delivering the rotation power from the driver handle along the driver's axis (313), a driver part of working axis (310) performing a work.

Torque transmission part is a combination of a loop, a gear, a wire, or a tube.

FIG. 3 is a diagram of free angle driver with loops type angle portion (309). If the handle is rotated, the loops transmit the torque, along the driver's working end.

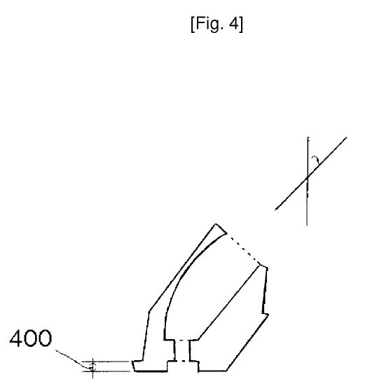

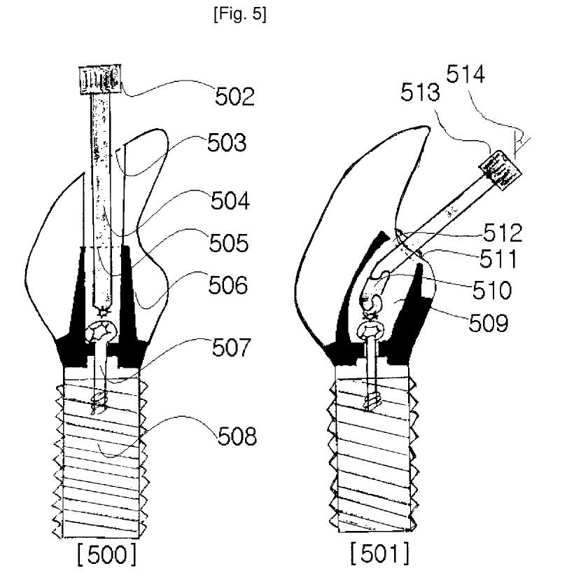

FIG. 5 is a diagram of prostheses (501), in which torque transmission part of two loops makes screwing and unscrewing easily through inducing tube of screw hole (509)

Free angle driver's length from working end (310) to torque transmission part (309) should be short enough, because those parts should be located in the abutment

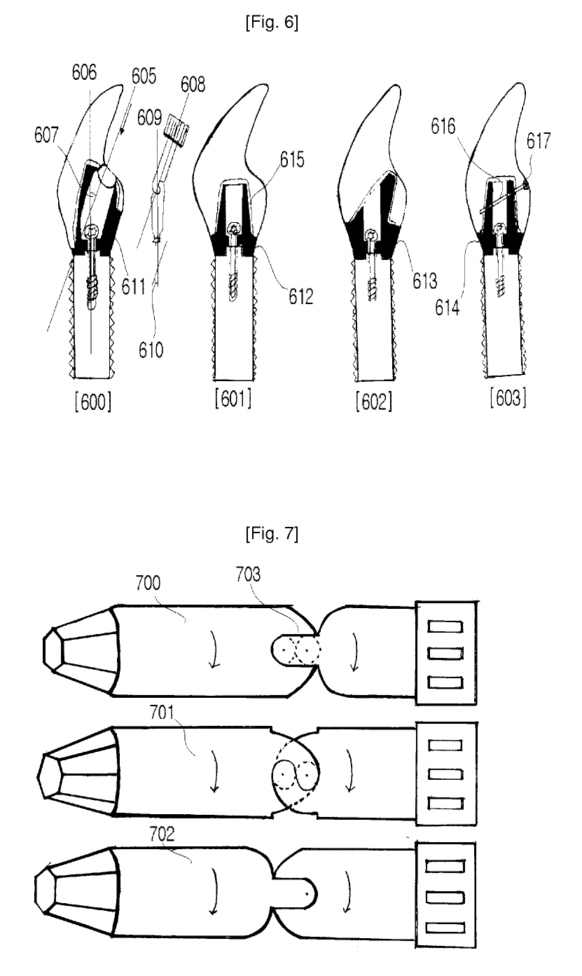

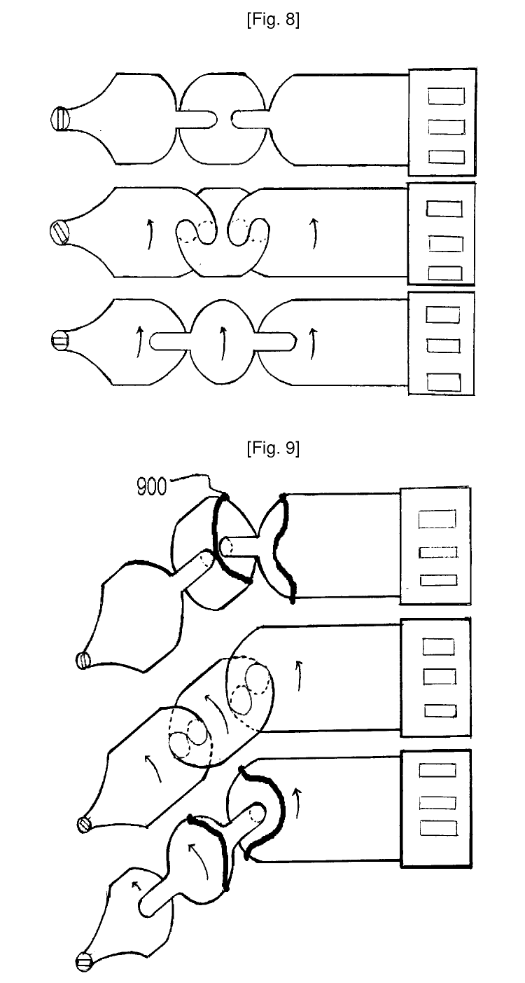

FIGS. 7,8 is a diagram of many torque transmission devices in use.

FIG. 9 is a diagram of joint angle limiting device (900), which is preventing the breakdown of driver and prosthesis.

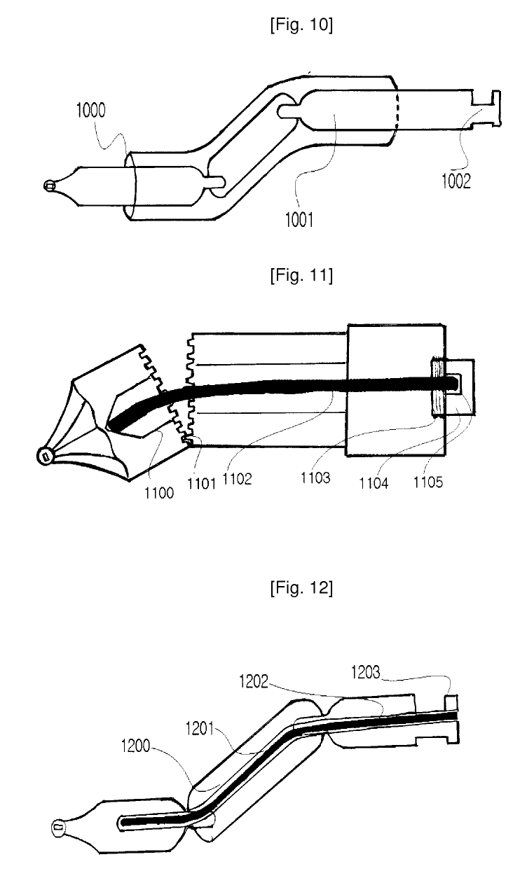

And, FIG. 10.11.12 is a diagram of a path guiding device (1000) which introduce its action from a power axis (312) to the driver's axis (313), this device consists of the tubes or the wires.

The free angled hole abutment (300) has a curved buccal surface of internal tube in abutment screw hole. It is aim to have capability of screwing and unscrewing easily. Lingual surface is straight for screw. The entrance of screw inserting hole (306) is located apart from central axis line of abutment screw (606)

Therefore, it is an esthetic and functional prosthesis. And it is capable of screwing and unscrewing easily.

As seen in UCLA type prosthesis, esthetice buccal margin are also seen in free angled hole abutment. Short metal collar are seen in this abutment (FIG. 4)

Finally, convenience and esthetics are come together in my invention.

### INDUSTRIAL APPLICABILITY

If we use the free angled driver (301) and free angled hole abutment (300), for maxillay anterior teeth, we can move the screw hole to lingual surface of prosthesis (511). we can make esthetic and convenient prosthesis with capability of easy screwing and unscrewing.

Also, for posterior teeth, with free angled hole abutment, we can move occlusal hole to ideal position. There are many benefits in the function and the beauty.

1. The free angled implant driver (301) used for implant, a feature of;
a driver handle (308) or a handpiece-type connection (1002) of a power axis (312); a torque transmission part (309) delivering the rotation power from the driver handle along the driver's working axis (313); a driver edge of working axis (310) performing a work; a path guiding device (1000) to introduce its action from a power axis (312) to the driver's axis (313);

2. The free angled implant driver of claim 1, has torque transmission part. In which, the angle (311) between a power axis (312) and driver's axis (313) will be from 1 to 89 degree, and that is combination of loops, gears, wires, or tubes, those are 1 to 10 in number.

3. The free angled implant driver of claim 1, has a path guiding device (1000) to introduce its action from a power axis (312) to the driver's axis (313), and the device consists of the tube or the wire. (FIG. 10, FIG. 11, and FIG. 12)

4. The free angled implant driver of claim 1, can be have a apparatus limiting the angle between a power axis and driver's axis in the torque transmission part. (FIG. 9)

5. The free angled implant driver of claim 1, torque transmission part (309) can be consisted with 1 to 10 piece in number, and will be located within 10 mm from the working end of driver (310).

6. The free angled hole abutment (300) with the free angled implant driver (301), has the entrance of screw inserting hole (306) which is located apart from central axis line of abutment screw (606), at a distance.

7. The free angled hole abutment of claim 6, esthetical prosthesis's buccal margin (400) of a free angled hole abutment is from 0.1 mm to 5 mm in height.
